(19) United States
(12) Patent Application Publication
(10) Pub. No.: US 2023/0172698 A1
(43) Pub. Date: Jun. 8, 2023

(54) CORDLESS DENTAL AIR/WATER SYRINGE

(71) Applicant: Collin C. PALMQUIST, Watertown, SD (US)

(72) Inventor: Collin C. PALMQUIST, Watertown, SD (US)

(21) Appl. No.: 17/998,081

(22) PCT Filed: May 11, 2021
(86) PCT No.: PCT/IB2021/054028

§ 371 Date: Nov. 7, 2022

Related U.S. Application Data
(60) Provisional application No. 63/022,911, filed on May 11, 2020.
(60) Provisional application No. 63/065,751, filed on Aug. 14, 2020.

(51) Int. Cl. A61C 17/02; A61C 17/022

(52) U.S. Cl. CPC A61C 17/0202; A61C 17/0217; A61C 17/022; A61C 2204/002

(57) ABSTRACT

A cordless dental gas/water syringe is provided. The cordless dental gas/water syringe can be freely carried and operated by a dental practitioner within a dental facility. The cordless dental gas/water syringe includes a portable or wearable body. The body includes a water chamber, a water pump, a gas chamber, a gas valve, a water switch, a gas switch, and a conduit system for fluidic connection. The body can also include a controller including a touch panel and/or a button for controlling the gas switch, the water switch, the gas valve, and/or the water pump.

### FIELD

This disclosure generally relates to a device that can supply a stream of gas and/or water. Specifically, this disclosure relates to a dental device used to, for example, wet, clean, and/or dry a dental or oral surface. More specifically, this disclosure is directed to a mobile cordless dental gas/water syringe.

### BACKGROUND

A traditional dental air/water syringe by itself does not possess an onboard air source or a water reservoir. As such, the traditional dental air/water syringe cannot function on its own but needs to maintain a constant connection with a dental air/water delivery system installed in a dental facility during its operation. The traditional dental air/water syringe is physically connected to the dental air/water delivery system. For example, the conventional dental air/water syringe is tethered to an outlet provided at a bracket attached to a dental chair, of the dental air/water delivery system. The traditional dental air/water syringe has limited mobility. Also, once the traditional air/water syringe is attached to the dental air/water delivery system, it is normally not removed to go through a sterilization process.

### SUMMARY

Embodiments herein relate a cordless dental gas/water syringe. In an embodiment, the cordless dental gas/water syringe is wearable, portable, and/or carriable.

The cordless dental gas/water syringe includes a body. The body includes a water chamber, a gas chamber, a water pump, a gas valve, and a battery for powering the water pump. The water chamber is capable of storing water or accommodating a container capable of storing water. The gas chamber is capable of accommodating a gas container capable of storing a pressurized gas. In an embodiment, the gas container is a canister.

The body can further include an adapter. The adapter connects the water chamber and the gas chamber with a gas/water tip.

In an embodiment, the body is configured to a handle and a head extending from the handle. In an embodiment, the handle includes a grooved surface facilitating an operator to grip the cordless dental gas/water syringe. The adapter is provided at a distal end of the head and includes a connector for connecting a gas/water tip.

In another embodiment, the cordless dental gas/water syringe further includes a syringe head and a conduit. The conduit fluidly connects the syringe head with the adapter of the body. The conduit includes at least one water conduit and at least one gas conduit. In an embodiment, the conduit further includes at least one electric wire. The syringe head has a gas/water tip connector for connecting a gas/water tip. In an embodiment, the body is capable of being attached to a belt. In an embodiment, the belt is a waist belt or arm belt.

In an embodiment, the cordless dental gas/water syringe further includes one or more of a gas switch, a water switch, and a water-refilling switch. The gas switch is capable of turning on or off a gas flow from the gas chamber to a working area. The water switch is capable of turning on or off a water flow from the water chamber to the working area. The water-refilling switch is capable of quickly refilling the water chamber with water or an aqueous solution.

In an embodiment, each of the gas switch, the water switch, and the water-refilling switch includes a button. In an embodiment, the buttons of the gas switch and the water switch are thumb-operated buttons.

In an embodiment, the water chamber has a mechanism via which a chemical tablet or solution is added into water or an aqueous solution. In an embodiment, the chemical tablet or solution is capable of neutralizing an unpleasant taste or destroying and/or suppressing a cariogenic bacterium.

In an embodiment, the cordless dental gas/water syringe further comprises a port for refilling water and/or gas. In an embodiment, the port is capable of retrofitting the existing outlet, piping, or tubing of a dental air/water delivery system in a dental facility.

In an embodiment, an LED light is provided on the head or the syringe head for illuminating a working area.

In an embodiment, the body further comprises a display and an optional button. In an embodiment, the display can display a graphical user interface (GUI) that can provide a plurality of operating selections.

### BRIEF DESCRIPTION OF THE DRAWINGS

References are made to the accompanying drawings that form a part of this disclosure, and which illustrate embodiments in which the devices described in this application can be practiced.

FIG. 1 schematically illustrates a cordless gas/water syringe, according to an embodiment.

FIG. 2 schematically illustrates a cordless gas/water syringe, according to an embodiment.

FIG. 3 schematically illustrates a cordless gas/water syringe, according to an embodiment.

FIG. 4 schematically illustrates a cordless gas/water syringe of FIG. 4A, according to an embodiment.

FIG. 5 schematically illustrates a cordless gas/water syringe of FIG. 4A, according to another embodiment.

FIG. 6A schematically illustrates an exploded view of a detachable connection between a cordless gas/water syringe and an existing air/water tubing in a dental facility, according to an embodiment.

FIG. 6B schematically illustrates an exploded view of a detachable connection between a cordless gas/water syringe and an existing air/water tubing in a dental facility, according to another embodiment.

FIG. 7 schematically illustrates a coupler of the coupling device of FIGS. 6A and B, according to another embodiment.

FIG. 8 schematically illustrates an adapter, according to an embodiment.

Like reference numbers represent like parts throughout.

### DETAILED DESCRIPTION

This disclosure generally relates to a device for supplying a stream of air and/or water. Specifically, this disclosure is directed to a dental gas/water syringe. More specifically, this disclosure is directed to a mobile cordless dental gas/water syringe.

The terminology used herein is intended to describe particular embodiments and is not intended to be limiting. The terms “a” “an”, and “the” include the plural forms as well unless indicated otherwise. The terms “comprises” and/or “comprising” specify the presence of the stated features, integers, steps, operations, elements, and/or components, but do not preclude the presence or addition of one or more other features, integers, steps, operations, elements, and/or components.

Certain values herein are preceded by the term “about”. The term “about” herein provides literal support for the exact value that it precedes, as well as a range that is near to or approximately the exact value. In an embodiment, the range is from 70% to 130% of the exact value that the term “about” precedes. In an embodiment, the range is from 80% to 120% of the exact value that the term “about” precedes. In an embodiment, the range is from 90% to 110% of the exact value that the term “about” precedes. In an embodiment, the range is from 99% to 101% of the exact value that the term “about” precedes. For example, if the exact value is 100, the range from 70% to 130% of the exact value is 70 to 130.

The term “/” in “gas/water” or “air/water” or the like means “and/or”.

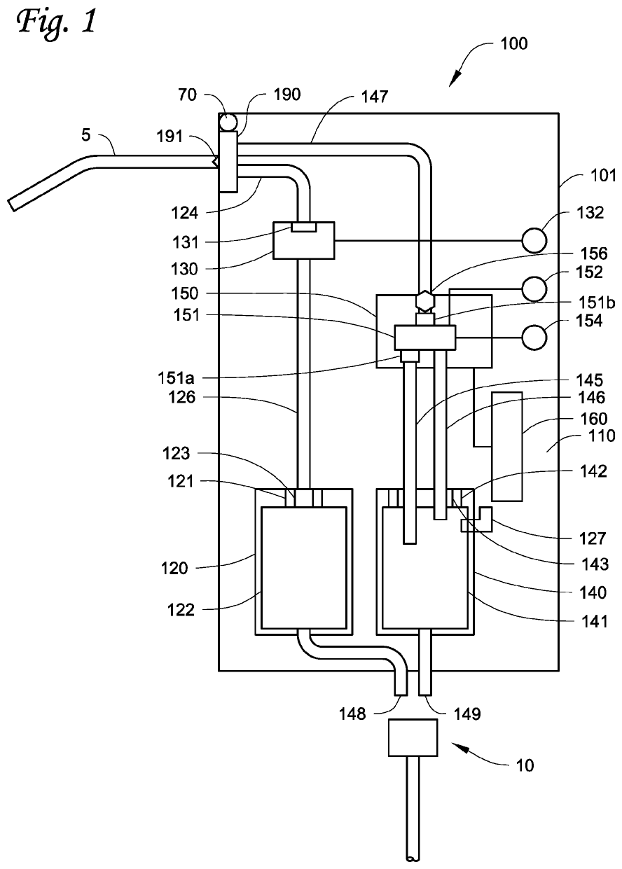

FIG. 1 is a schematic diagram of a cordless gas/water syringe 100, according to an embodiment. The cordless gas/water syringe 100 includes a body 101. The body 101 includes a housing 110 that contains a gas chamber 120, a gas valve 130, a water chamber 140, a pumping system 150, and a battery 160 capable of powering the pumping system 150.

The gas chamber 120 is capable of storing a pressurized gas. The gas chamber 120 can be a removable or irremovable chamber. In an embodiment, the gas chamber 120 is capable of storing a pressurized gas on its own. In an embodiment, the gas chamber 120 is a chamber capable of receiving and accommodating a removable gas container 122 storing a pressurized gas. In an embodiment, the gas container 122 is a commercially available compressed gas container so that a commercially available compressed gas can be used for a dental operation. In an embodiment, the gas container 122 is a canister containing pressurized air. The pressurized air can be used to provide chip air. “chip air,” as used herein, generally refers to an airflow used to clear debris during a dental procedure.

The gas can be any gas suitable for dental operation such as, for example, cleaning or surgery. In an embodiment, the gas is air. In an embodiment, the gas is CO₂. In an embodiment, the gas is N₂.

In an embodiment, the gas chamber 120 can have a receiving mechanism 121 for connecting and locking the gas container 122, for example, air canister. In an embodiment, the receiving mechanism 121 can include a male or female adapter that can fit onto a female or male adapter on the gas container and form a gas passage. In an embodiment, the gas container 122 is provided with an engaging mechanism 123 for latching onto the receiving mechanism 121 of the gas chamber 120. In an embodiment, the receiving mechanism 121 and the engaging mechanism 123 includes a pair of female and male fittings. In an embodiment, the female and male fittings include threads.

The gas container 122 can be in fluid connection with an adapter 190. The gas flow from the gas container 122 to the adapter 190 can be regulated or controlled by a gas valve 130. In an embodiment, a regulator 131 is also provided for regulating the pressure of gas flowing to the dental or oral surface. In an embodiment, the regulator 131 is integrated with the gas valve 130. In an embodiment, the regulator 131 and the gas valve 130 are separate devices. The regulator 131 can reduce the input gas pressure to the desired value suitable for dental procedures at its output. In an embodiment, the regulator 131 includes an output pressure setting, a restrictor, and a sensor all in one body. In an embodiment, the regulator 131 is not an integrated device but includes separate devices. In an embodiment, the regulator 131 can include a separate pressure sensor, controller, and/or flow valve.

In an embodiment, the size of the gas chamber 120 or the gas container 122 can be configured to hold a sufficient amount of gas for one or more dental operations while allowing mobility and portability of the cordless gas/water syringe. In an embodiment, the gas chamber 120 or the gas container 122 can contain at or about 2 grams to at or about 20 grams of compressed gas. In an embodiment, the gas chamber 120 or the gas container 122 can contain at or about 12 grams to at or about 16 grams of compressed gas. In an embodiment, the gas chamber 120 or the gas container 122 can accommodate a compressed gas up to at or about 8 grams. In an embodiment, the gas chamber 120 or the gas container 122 can accommodate a compressed gas of at or about 1 ounce, at or about 2 ounces, at or about 3 ounces, at or about 4 ounces, at or about 5 ounces, or at or about 5 ounces. In an embodiment, the compressed gas can have a pressure up to at or about 120 psi. In an embodiment, the pressure is in a range of at or about 100 to at or about 120 psi. Each of the gas chamber 120 and the gas container 122 can be independently made from a suitable material for containing compressed gas. In an embodiment, the material includes but not limited to, for example, metal, plastic, elastomer, ceramic, carbon, glass, a combination thereof, or the like. In an embodiment, the material is an autoclavable material. In an embodiment, the material is a non-autoclavable material.

In an embodiment, a gas inlet port 148 can be provided for refilling gas into the gas chamber 120 or the gas container 122. The gas inlet port 148 can directly or indirectly fit and connect with an existing gas port, gas tubing, and/or piping of a gas source/reservoir in a dental facility for gas refilling.

The gas valve 130 can also include a gas switch 132. The gas switch 132 can turn on or shut off the gas flow. In an embodiment, when the gas switch 132 is turned on, the gas valve 130 is on, releasing the gas into an adapter 190 via a tube 124 from the gas container. In an embodiment, when the gas switch 132 is off, the gas valve 130 is off, resulting in no gas flowing into the adapter 190. In an embodiment, the gas switch 132 is normally off. In an embodiment, the gas switch 132 is a mechanical switch. In an embodiment, the gas switch 132 is an electric switch.

The water chamber 140 can be a removable or irremovable water chamber for storing water or an aqueous solution useful in, for example, dental cleaning and surgery. In an embodiment, the water chamber 140 alone can store water or an aqueous solution. In an embodiment, the water chamber 140 is a removable or replaceable water compartment in the housing 110. In an embodiment, the removable water compartment is a disposable or non-disposable water bottle, for example, a commercially available plastic or glass water bottle, so that the bottled water in the market can be used for a dental operation.

In an embodiment, the water chamber 140 is a chamber for receiving and accommodating a water container 141 capable of storing water or a water solution. In an embodiment, the container 141 can be a water bottle, for example, commercially available plastic or glass water bottle, so that the bottled water in the market can be used for a dental operation.

In an embodiment, the water chamber 140 can have a receiving mechanism 142 for forming a non-leak connection with the water container 141. In an embodiment, the receiving mechanism 142 includes a fitting adapted to connect with the water container 141. In an embodiment, the water container 141 can include a locking mechanism 143 for connecting the receiving mechanism 142 of the water chamber 140. In an embodiment, the receiving mechanism 142 and the locking mechanism 143 are a pair of male and female fittings. In an embodiment, the fittings each include a thread.

Each of the water chamber 140 and the water container 141 can be independently made from a suitable material for containing water. In an embodiment, the material includes but not limited to, for example, metal, plastic, elastomer, ceramic, carbon, glass, a combination thereof, or the like. In an embodiment, the material can prevent bacterial or fungi growth. In an embodiment, the material is an autoclavable material. In an embodiment, the material is a non-autoclavable material.

In an embodiment, the size of the water chamber 140 or the water container 142 is configured to hold a sufficient amount of water for one or more dental operations while allowing mobility and portability of the cordless gas/water syringe. In an embodiment, the amount of water is in a range of at or about 3 to at or about 15 ounces. In an embodiment, the amount of water is in a range of at or about 3 to at or about 6 ounces. In an embodiment, the amount of water is in a range from at or about 5 to at or about 8 ounces.

In an embodiment, a water inlet port 149 can be provided for refilling water into the water chamber 140 or the water container 141. The water inlet 149 can directly or indirectly fitting and connecting with an existing water port, tubing, and/or piping of a water source/reservoir in a dental facility for water refilling.

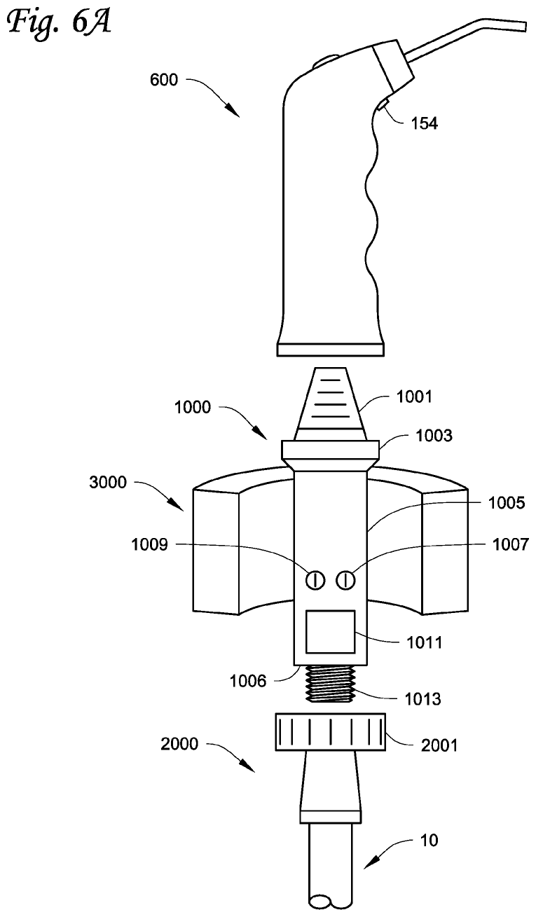

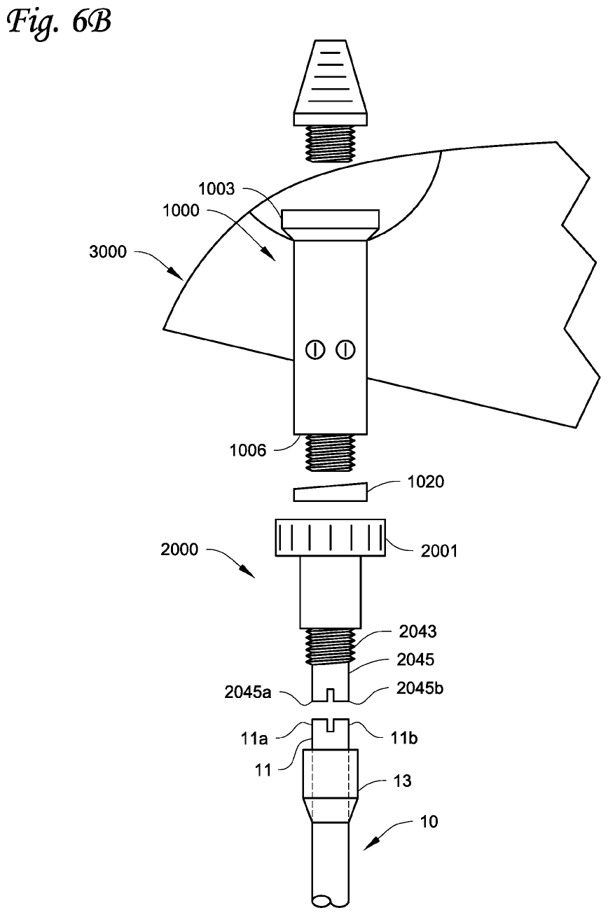

In an embodiment, the gas inlet 148 and the water inlet 149 directly or indirectly fits and connects with a water/gas port 10. In an embodiment, the gas inlet port 168 and the water inlet port 149 includes a fitting or adapter for retrofitting the water/gas port 10. In an embodiment, the gas inlet 148 and the water inlet 149 connect with the water/gas port 10 via a coupling device, examples of which are shown in FIGS. 6A, 6 B, and 7-9. In an embodiment, the cordless gas/water syringe 100 includes the coupling device so that it can directly be refilled with water/gas from an existing water/gas port 10 in a dental facility without additional modification. In an embodiment, the water/gas port 10 includes a tubing coupler so that it can directly connect with the gas inlet 148 and the water inlet 149 for refilling. An example of the tubing coupler is shown in FIG. 9. In an embodiment, the gas inlet port 48 and the water inlet port 149 can prevent gas and water leak, respectively, after the water/gas port 10 disconnects with them. In an embodiment, the inlet water port 149 includes a stopper for preventing water leak. In an embodiment, the stopper is a rubber seal.

The water chamber 140 can contain a mechanism 127 such as, for example, a lid, a sealable opening, a sealable window, or the like, via which a chemical tablet or solution may be added into the aqueous solution or water in the water chamber 140 or the container 141. In an embodiment, the chemical tablet can assist in neutralizing an unpleasant taste that often accompanies intraoral dental procedures. In an embodiment, the chemical tablet is an effervescent tablet. In an embodiment, the tablet can contain xylitol or the like. In an embodiment, the chemical tablet can also have antibacterial properties that destroy and/or suppress cariogenic bacteria.

The pumping system 150 is capable of drawing an aqueous solution, for example, water, from the water chamber 140, and discharge the aqueous solution to the adapter 190 via a tube 145 and a tube 147. The pumping system 150 can include one or more water pumps. In an embodiment, the pumping system 150 includes a centrifugal water pump that uses a rotating impeller to draw and discharge water. In an embodiment, the pumping system 150 includes a positive displacement pump. In an embodiment, the pumping system 150 includes a combination of a centrifugal water pump and a positive displacement pump. The centrifugal water pump can include but not limited to, for example, an axial flow pump, a mixed flow pump, and a radial flow pump. The positive displacement pump can include but not limited to, for example, rotary types positive displacement pump, reciprocating type positive displacement pump, linear type positive displacement pump, or the like. The reciprocating type positive displacement pump can include but not limited to, for example, a piston pump, plunger pump, and diaphragm pump. In an embodiment, the pumping system 150 can include a piston pump.

In an embodiment, the pumping system 150 includes a pump 151. In an embodiment, the tube 145 is connected at one end to an intake valve 151a of the pump 151 and, at the other end freely rests within the water chamber 140. In an embodiment, the tube 147 is connected with an exhaust valve 151b of the pump 151. In an embodiment, the intake valve 151a and/or the exhaust valve 151b are a one-way valve.

The pumping system 150 can also include a water switch 152 for regulating the fluidic flow between the pumping system 150 and the adapter 190. The water switch 152 can normally be off. In an embodiment, the water switch 152 is an electric switch that can break or make an electric circuit of the pumping system 150. In an embodiment, the water switch 152 can turn on and/or shut off the one or more pumps in the pumping system 150. In an embodiment, the water switch 152 can turn on and/or shut off one or more valves in the pumping system 150. In an embodiment, the water switch 152 can be a mechanical switch. The water switch 152 can normally be off.

In an embodiment, the water switch 152 can turn on or shut off the pump 151. In an embodiment, the pump 151 is in fluidic connection with the adapter 190 via a tube 147. When the water switch 152 is on, water is drawn from the water chamber 140 and discharged into the adapter 190.

In an embodiment, the pumping system 150 can further include a water-refilling switch 154 for quickly refilling water into the water chamber 140 or the container 141. In an embodiment, the water-refilling switch 154 can turn on the pump 151 for drawing water into the water chamber 140 from water/gas port 10 via the inlet 149. In an embodiment, the pump 151 can further fluidly connect with a tube 146 that has an opening in the water chamber 140, and when the water-refilling switch 154 is on, the pump 151 can draw air out of the water chamber 140 through the tube 146.

In an embodiment, the pumping system 150 can further include a flow regulator 156 for regulating the water flow rate. In an embodiment, the flow regulator 156 can be used to maintain a defined flow rate regardless of pressure variation. In an embodiment, the flow regulator 156 is a restrict valve. In an embodiment, the pumping system 150 can further include a water flow sensor or flow meter for measuring the water flow rate.

The cordless gas/water syringe 100 can include a gas/water tip 5. The gas/water tip 5 can direct the gas or water from the adapter 190 to a dental or oral surface. The gas/water tip 5 can include an elongated housing that contains at least one air conduit and at least one water conduit. In an embodiment, the gas/water tip 5 is disposable. In an embodiment, the gas/water tip 5 can be a non-reusable tip or reusable tip. In an embodiment, the gas/water tip 5 is a sterile non-reusable tip. In an embodiment, the gas/water tip 5 is autoclavable.

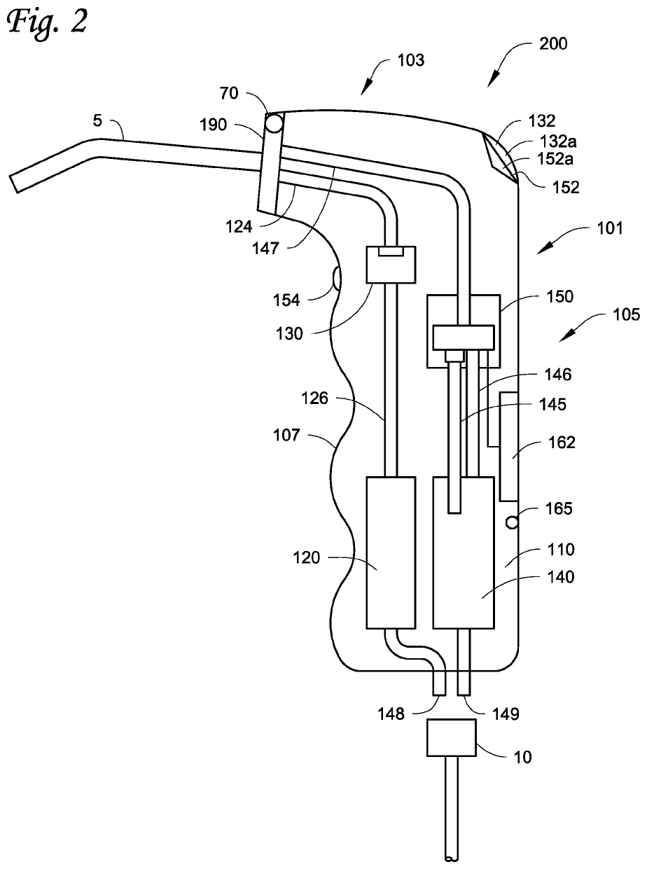

In an embodiment, the gas/water tip 5 can directly connect with the adapter 190. In an embodiment, the adapter 190 can include a connector 191. In an embodiment, the connector 191 has a fitting adapted to connect with the gas/water tip 5. In another embodiment, the gas/water tip 5 has a fitting adapted to fit the connector 191. A non-limiting example of the cordless gas/water syringe 100 that directly connects with the gas/water tip 5 is illustrated in FIG. 2 of this Specification.

In another embodiment, the gas/water tip 5 can indirectly connect with the adapter 190 via a conduit and syringe head. A non-limiting example of the cordless gas/water syringe 100 that indirectly connects with the gas/water tip 5 is illustrated in FIG. 2 of this Specification.

Each of the gas/water tip 5, the adapter 190, the water chamber 140, and the gas chamber 120 can independently be replaceable and made from one or more materials selected from plastic, metal, glass, ceramic, carbon, fiber, composite materials thereof, combinations thereof, and the like. The metal can include but not limited to stainless steel.

The gas/water tip 5, the adapter 190, the tube 147, the pumping system 150, the tube 145 can form a water passage whereby the aqueous solution or water within the water chamber 140 can flow to a dental or oral surface.

The gas/water tip 5, the 190, the tube 124, the gas valve 130, the tube 126, and the gas chamber 170 can form a gas passage whereby the gas within the gas container can flow to a dental or oral surface.

Various types of fittings can be used for mediating a fluidic connection between components of the cordless gas/water syringe 100. The fittings can include but not limited to, for example, couplings, unions, fasteners, valves, connectors, adapters, compression fittings, push-to-pull or push-fit fittings, or the like. The fittings can be made from a material including but not limited to, for example, stainless steel, non-ferrous metal, non-metallic material, chrome-molybdenum steel. The non-ferrous metal can include but not limited to, for example, copper, Inconel, Incoloy, and cupronickel. The non-metallic material can include, but not limited to, for example, polyvinyl chloride (PVC).

In an embodiment, the cordless gas/water syringe 100 includes a light 70. The light 70 can be powered by the battery 160. The light 70 can be provided at a location suitable for illuminating a working area of a dental or oral surface during a dental operation. In an embodiment, the light 70 is provided at a surface of the adapter 190. In an embodiment, the light 70 is a light-emitting diode (LED) or the like. In an embodiment, the light 70 includes a power switch for controlling on/off of the light 70.

The battery 160 can be removable from a battery chamber provided in the housing 110. The battery 160 can be a rechargeable or non-rechargeable battery. In an embodiment, the battery 160 can be charged in situ while still connected to the cordless gas/water syringe 100. In an embodiment, the battery 160 can be charged after being removed from the cordless gas/water syringe 100. The battery 160 can be any suitable chemical battery. In an embodiment, the battery 160 is a lithium-ion battery or the like. In an embodiment, the battery is a zinc battery or the like.

It is appreciated one or more features can be further included in the cordless gas/water syringe 100. For example, the cordless gas/water syringe 100 can further include a membrane for filtering a pathogen or particle, including but not limited to, for example, dust, virus, bacteria, or fungi. In an embodiment, the filter can have a pore size of at or about 0.01 μm to at or about 100 μm. In an embodiment, the membrane can have a pore size of at or about 0.22 μm. In an embodiment, the membrane is provided in the adapter 190. In an embodiment, the membrane is provided in the gas chamber 120 and the water chamber 140.

The cordless dental gas/water syringe 100 described above exhibits advantages over the conventional air-water syringe, as it can have its own water and gas source without being physically tied to an external water and gas delivery system during operation. This provides a dental professional with mobility and convenience so that the dental professional can carry and/or move the dental gas/water syringe 100 to anywhere he/she wishes to perform a dental procedure including but not limited to cleaning, wetting, and drying a dental or oral surface.

Referring to FIG. 2, FIG. 2 schematically illustrates a cordless gas/water syringe 200, according to an embodiment. The cordless gas/water syringe 200 can be a non-limiting example of the cordless gas/water syringe 100 of FIG. 1. The cordless gas/water syringe 200 can include structures and features of the embodiment of FIG. 1. For the simplicity of the description, some features which are the same are labeled with like reference numbers and are not described in further detail. For the simplicity of the drawings, some features shown in FIG. 1 are not shown or labeled in FIG. 2, for example, the mechanical connection or electric connection between the gas/water switch 152 and the pumping system 150. It is appreciated that the gas/water syringe 200 may include these features not shown or labeled in FIG. 2 unless stated otherwise.

The body 101 of the cordless gas/water syringe 200 can have an elongated, curved shape, forming a general configuration of a gun with a head 103 and a handle 105.

The gas/water tip adapter 190 can be provided on the distal end of the head 103. In an embodiment, the light 70 is also provided on the distal end of the head 103.

The handle 105 can include a grooved surface 107 that can facilitate gripping of the handle 105 by a dental professional. In an embodiment, the inlet port 149 is provided on the bottom surface of the distal end of the handle 105 for connecting with the water/gas port 10.

The water chamber 140 and the gas chamber 120 can be disposed substantially within the handle 105. In an embodiment, the water pump system 150 and the gas valve 130 can also be disposed roughly within the middle portion of the body 101.

A battery chamber 162 can be provided within the handle 105 for housing the battery 160. The battery chamber 162 can have a removable cover on a surface of the handle 105 for removing or installing a battery. In an embodiment, the cover situates at the bottom surface of the distal end of the handle 105. In an embodiment, the cover situates at a side surface of the handle 105. In an embodiment, a charge port 165 is provided on the handle 105 for charging the battery 160. In an embodiment, the charge port 165 can electrically connect with a charger for in situ charging the battery 160.

In an embodiment, the gas switch 132 includes a button 132a; when pressed, the gas switch 132 is on, allowing gas to flow into the adapter 190 from the gas chamber 120. In an embodiment, the water switch 152 includes a button 152a; when pressed, the water switch 152 is on, moving water into the adapter 190 from the water chamber 140. In an embodiment, the button 132a and 152a are thumb-operable. In an embodiment, the button 132a and the button 152a can be parallelly disposed on a surface extending between the head 103 and the handle 105, so that, while the dental professional grip the handle 105, his/her thumb can easily press the buttons 132a and 152a.

In an embodiment, the water-refilling switch 154 includes a button 154a; when pressed, the water refills the water chamber 140. In an embodiment, the water refilling button 154a resides at a site generally opposing to the buttons 132a and 152a and can be easily and conveniently pressed by the index finger while the dental professional grips the handle portion 105.

The cordless gas/water syringe 200 can have a size suitable for being freely carried and/or moved by an operator within the dental facility. In an embodiment, the handle 105 has a diameter or width of about 15 mm. In an embodiment, the cordless gas/water syringe 200 has a length in a range from 100 to 180 mm. In an embodiment, the cordless gas/water syringe 200 can be attached to a belt, a pocket, or the like. In an embodiment, the cordless gas/water syringe 200 includes a clip, a hook, or the like for hanging the cordless gas/water syringe 200 onto the belt or pocket or the like. In an embodiment, the belt is a waist or belly belt, or the like. In an embodiment, the belt is an arm belt or the like.

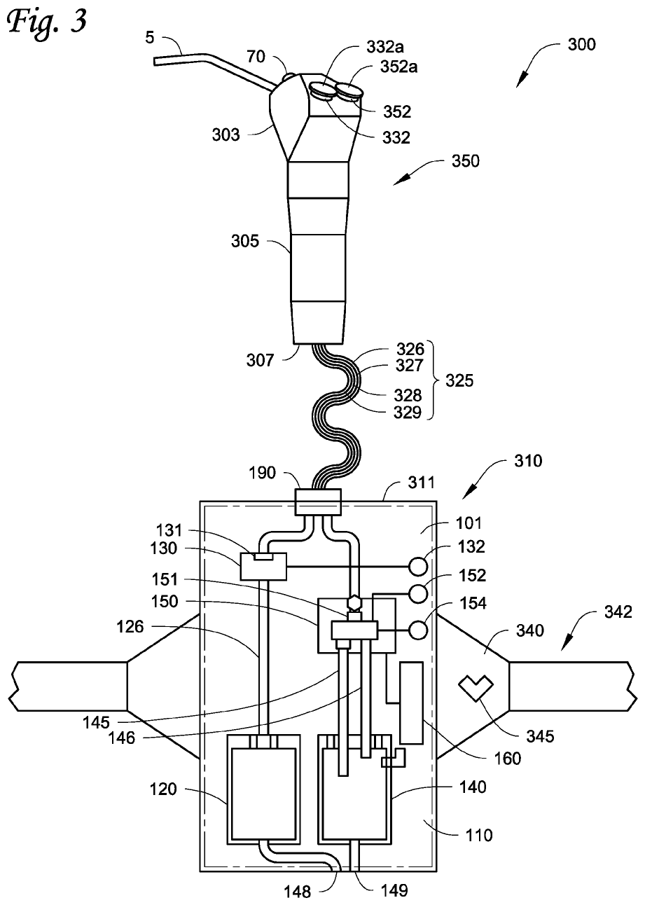

Referring to FIG. 3, FIG. 3 schematically illustrates a cordless gas/water syringe 300, according to an embodiment. The cordless gas/water syringe 300 can be another non-limiting example of the cordless gas/water syringe 100 of FIG. 1. The cordless gas/water syringe 300 can include structural features discussed with respect to the cordless gas/water syringe 100 of FIG. 1. For the simplicity of the description, some features which are the same are labeled with like reference numbers and are not described in further detail. For the simplicity of the drawings, some features shown in FIG. 1 are not shown or labeled in FIG. 3, but the gas/water syringe 300 may include these features unless stated otherwise.

The cordless gas/water syringe 300 can include a wearable body 310, a conduit 325, and a syringe head 350. The wearable body 310 includes a housing 311 for holding the body 101 or the structures described with respect to FIG. 1. The wearable body 310 can also include a hanger 340 for attaching the wearable body 310 to a belt 342. The hanger can have any structure suitable for attaching the wearable body 310 to the belt 342. In an embodiment, the hanger 340 includes a clip, a hook, or the like for attaching the cordless gas/water syringe 300 to the belt 342. In an embodiment, the belt 342 is a waist or belly belt. In an embodiment, the belt 342 is an arm belt.

The housing 311 can be a rigid or semi-rigid structure. In an embodiment, the housing 311 can be made of a material including a suitable lightweight material. Examples of suitable lightweight materials include, for example, polypropylene, polyester, polyvinylchloride, polyethylene, fabric, leather, carbon, fiber, or the like. It will be appreciated that other lightweight materials may provide sufficient rigidity for the housing 311. In an embodiment, an overall weight and size of the cordless gas/water syringe 300 can be limited to avoid interfering with the operator's motion during a procedure. In an embodiment, the housing 311 may also include an adjustable fastener. The adjustable fastener can include, for example, Velcro, a snap, a buckle, a button, a plurality of buttons, combinations thereof, or the like.

In an embodiment, the wearable body 310 can also include a holder 345 for holding the syringe head 350 when it is not in use. The holder 345 can be configured insomuch that an operator can detach or attach the syringe head 350 easily and conveniently. In an embodiment, the holder 345 is a clip.

Conduit 325 can fluidly connect the syringe head 350 with the wearable body 310. In an embodiment, the conduit 325 removably connects to the adapter 190 of the wearable body 310. In an embodiment, the conduit 325 removably connects to the syringe head 350 without the use of an additional tool so that, for example, the syringe head 350 can be replaced before or during a dental procedure. For example, if the syringe head 350 needs to be autoclaved or an issue occurs with the current syringe head 350, or the like, the syringe head 350 may be changeable without the use of tools.

In an embodiment, the conduit 325 can removably connect to the wearable body 310 without the use of an additional tool so that, for example, the wearable body 310 can be replaced before or during a dental procedure. In an embodiment, the conduit 325 has a fitting or an adapter for removably connecting to the adapter 190 of the wearable body 310 and/or the syringe head 350.

In an embodiment, the syringe head 350 has a configuration of a conventional dental gas/water syringe. In an embodiment, the syringe head 350 includes an end portion 303 and a handle portion 305. In an embodiment, a water switch 352 and a gas switch 332 can be provided on a surface of the end portion 303. The water switch 352 and gas switch 332 can normally be off. In an embodiment, the water switch 352 includes a button 352a; when pressed, the water switch 352 is on, moving water into the gas/water tip 5 from the water chamber 140. In an embodiment, the gas switch 332 includes a button 332a, when pressed, the gas switch 332 is on, moving gas into the gas/water tip 5 from the gas chamber 120. In an embodiment, the button 332a and 352a are thumb-operable.

In an embodiment, the syringe head 350 has a length in a range from at or about 100 mm to at or about 180 mm. In an embodiment, the bottom 307 of the syringe head 350 has a diameter of at or about 15 mm.

In an embodiment, the water-refilling switch 154 can be provided on a surface of the syringe head 350 or the wearable body 310. In an embodiment, the water-refilling switch 154 is provided on a surface of the gas/water syringe 300. In an embodiment, the water-refilling switch 154 can include a button 154b; when pressed, water can quickly refill the water chamber 140.

The conduit 325 can contain a plurality of conduits. In an embodiment, the conduit 325 can include at least one water conduit 326 and at least one gas conduit 327. In an embodiment, the conduit 325 can further include an electric wire 328 for providing power to the light 70 provided on the syringe head 350. In an embodiment, the conduit 325 can further include an electric wire 329 for electrically connecting the water switch 352 with the water pumping system 150, so that the water pumping system 150 can be activated when the water switch 352 is on. The conduit 325 can be covered or enclosed with a sheath.

It will be appreciated that one or more of the features may be optional, according to an embodiment. In an embodiment, the gas switch 332 and/or the water switch 352 are optional. In an embodiment, the gas/water syringe 300 does not include the gas switch 332 and the water switch 352 but includes the gas switch 132 and the water switch 152. In an embodiment, the gas switch 132 and/or the water switch 152 are optional. In an embodiment, the gas/water syringe 300 does not include the gas switch 132 and the water switch 152 but includes the gas switch 332 and the water switch 352.

In an embodiment, the size of the water chamber 140 accommodates water in an amount from at or about 5 to at or about 8 ounces. In an embodiment, the size of the gas chamber accommodates an air canister containing up to at or about 2, 4, 6, 8, or 10 ounces of compressed air.

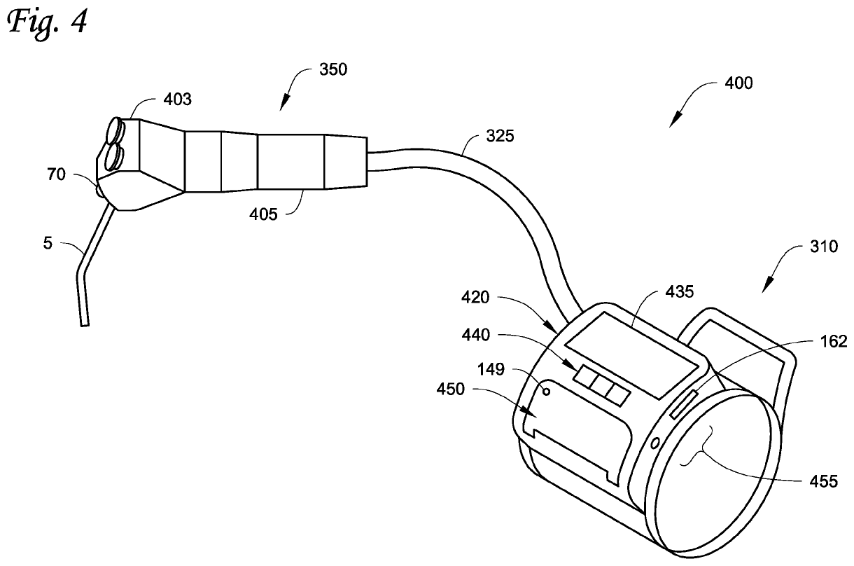

Referring to FIG. 4, FIG. 4 schematically illustrates a cordless gas/water syringe 400, according to an embodiment. The cordless gas/water syringe 400 can include structural features of the embodiments of FIGS. 3A and 1. For simplicity of this Specification, these structural features of the embodiments of FIGS. 1 and 3 are not further described but incorporated herein. For the simplicity of the drawings, features shown in FIGS. 1 and 3 are not shown or labeled in FIG. 4, but the gas/water syringe 400 may include these features unless otherwise specifically indicated.

Compared to the embodiment of FIG. 3, a wearable controller 420 is provided on the wearable body 310 of the cordless gas/water syringe 400. In an embodiment, the wearable controller 420 can control some components such as, for example, the gas switch 132, the water switch 152, and/or the water-refilling switch 154. In an embodiment, the controller 420 includes a display 435 and an input 440 so that an operator can select controls for the cordless gas/water syringe 400. In an embodiment, the wearable controller 420 may be in electric communication with the gas switch 132, the water switch 152, and/or the water-refilling switch 154, regulating their on/off via a button, touch screen, voice control, or the like. In an embodiment, the wearable controller 420 is integrated with the gas switch 132, the water switch 152, and the water-refilling switch 154. In an embodiment, the wearable controller 420 can be in electric communication with the gas valve 130 and/or the pumping system 150, regulating the flow rates of gas and/or water onto the working area. The electric communication may be wired or wireless communication. The battery 160 can be installed in the battery chamber 162 for providing power to the cordless gas/water syringe 400.

In an embodiment, the wearable controller 420 may have a particular orientation so that the wearable controller 420 is suitable for a right-handed operator or a left-handed operator. In an embodiment, the wearable controller 420 may be orientation agnostic so that, for example, a left-handed operator and a right-handed operator can use the same wearable controller 420.

The operator may configure one or more operating parameters for the cordless gas/water syringe 400, via a variety of menu options on the display 435. In an embodiment, the wearable controller 420 may include options associated with predefined parameters (e.g., flow rate, gas pressure, or the like.) for the cordless gas/water syringe 400. In an embodiment, the settings may be configurable by the operator. In an embodiment, the operating parameters may be selected at a time of manufacture based on, for example, best practices in dentistry, standards, or the like.

The display 435 can include a variety of display devices suitable for displaying information to the user. Examples of devices suitable for the display 435 include, but are not limited to, a liquid crystal display (LCD), a light-emitting diode (LED) display, or the like. The display 435 can be used, for example, to display feedback to the user such as, but not limited to, gas pressure, gas flow rate, runtime, water pressure, water flow rate, or the like. It will be appreciated that this list is an example and that additional information can be displayed in accordance with the principles described in this Specification.

The input 440 can include a variety of input devices or computer-readable means suitable for receiving an input from the user. Examples of devices suitable for the input 440 include, but are not limited to, a button or the like. In an embodiment, the input 440 can be integrated with the display 435 such that both input and output can be performed by the display 435. Such an embodiment is shown and described in accordance with FIG. 4 below.

In the illustrated embodiment, the input 440 includes three buttons. It is appreciated that the number of buttons may vary. In an embodiment, the number of buttons is more than three or less than three. In an embodiment that includes three buttons, one of the buttons may be a power/menu button and the other two buttons may be an up button and a down button for scrolling through various commands or options on the display 435. In an embodiment, the power/menu button may also be used for making a selection.

The water chamber 140 and the gas chamber 120 can be provided in a housing 450. In an embodiment, the water chamber 140 can allow storing from at or about 2 ounces to at or about 3 ounces of fluid. In an embodiment, the water chamber 140 can store at or about 2.5 ounces of fluid. In an embodiment, the water chamber 140 can store at or about 500 ml of fluid. The water chamber 140 can be removable from the wearable controller 420. The water port 149 can enable the refilling of the water chamber 140 even when the wearable body 310 is on the operator's arm or waist (e.g., during a procedure). As such, an assistant or the like can refill the reservoir without delaying the procedure.

The wearable body 310 can generally include a processor, a memory, storage, and a network input/output. The processor can retrieve and execute programming instructions stored in the memory and/or the storage. The processor can also store and retrieve application data residing in the memory. The processor can be a single processor, multiple processors, or a single processor having multiple processing cores. In an embodiment, the processor can be a single-threaded processor. In an embodiment, the processor can be a multi-threaded processor. The memory is generally included to be representative of a random access memory such as, but not limited to, Static Random Access Memory (SRAM), Dynamic Random Access Memory (DRAM), or Flash. In an embodiment, the memory can be a volatile memory. In an embodiment, the memory can be a non-volatile memory. In an embodiment, at least a portion of the memory can be virtual memory. The storage is generally included to be representative of a non-volatile memory such as, but not limited to, a hard disk drive, a solid-state device, removable memory cards, optical storage, flash memory devices, network-attached storage (NAS), or connections to storage area network (SAN) devices, or other similar devices that may store non-volatile data. In an embodiment, the storage is a computer-readable medium. In an embodiment, the storage can include storage that is external to the computer device, such as in a cloud. The network I/O is configured to transmit data via a network. The network may alternatively be referred to as the communications network. Examples of the network include, but are not limited to, a local area network (LAN), a wide area network (WAN), the Internet, or the like. In an embodiment, the network I/O can transmit data via the network through a wireless connection using Wi-Fi, Bluetooth, or other similar wireless communication protocols. In an embodiment, the wearable body 310 can transmit data via the network through a cellular, 3G, 4G, or other wireless protocol.

In an embodiment, the wearable body 310 can include an output 455. The output 455 may be a speaker, a vibrator, or the like. In an embodiment, the output 455 can be a speaker and a vibrator. The output 455 can receive an electric alert signal from the wearable controller 420. In response to the alert signal, the output 455 generates a sound or a vibration to alert the operator of, for example, an excessive pressure, a low battery, or the like.

The head 350 can have a configuration similar to the conventional dental air-water syringe. The head 350 can include an end portion 403 and a handle portion 405. The gas/water tip adapter 190 can be provided on the distal end of the end portion 403. In an embodiment, the light 70 is provided on a surface of the end portion 403.

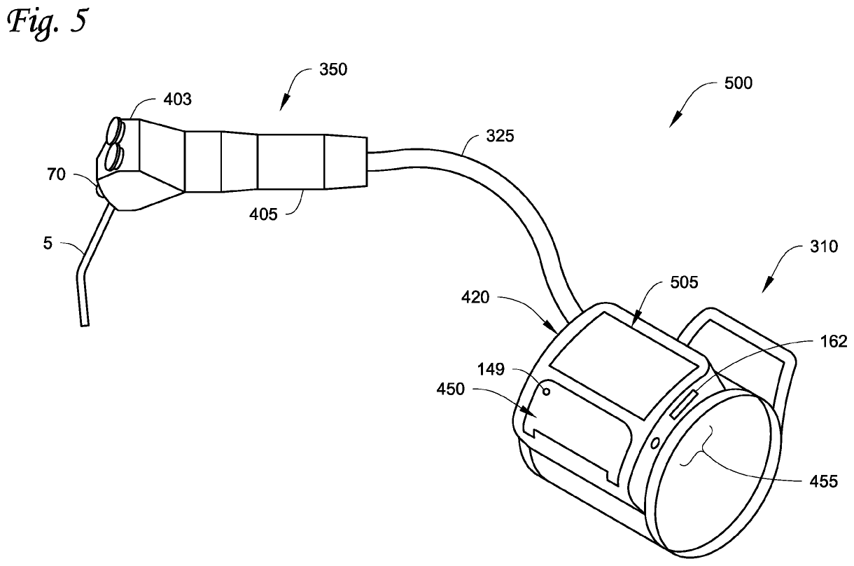

FIG. 5 schematically illustrates a cordless gas/air syringe 500, according to an embodiment. This embodiment is similar to the cordless gas/air syringe 400 in FIG. 4. For simplicity of this Specification, some features which are the same are labeled with like reference numbers and are not described in further detail. Compared to the embodiment in FIG. 4, this embodiment includes a touchscreen display 505. The touchscreen display 505 incorporates the display 435 and the input 440 in FIG. 4 into a single touchscreen display. In an embodiment, the touchscreen display 505 may provide additional menu options instead of having the three buttons in FIG. 4. The touchscreen display 505 can be a color display or a black-and-white display.

The touchscreen display 505 can include a variety of input devices or input means suitable for receiving an input from the user. Examples of devices suitable for the input include, but are not limited to, a voice command, a proximity sensor, an ocular sensing device for determining an input based on eye movements (e.g., scrolling based on an eye movement), or the like.

Referring to FIG. 6A, FIG. 6A schematically illustrates an exploded view of a detachable connection of a cordless gas/water syringe 600 with an air/water tubing 10 in a dental facility, according to an embodiment. In an embodiment, the cordless gas/water syringe 600 is the cordless gas/water syringe 100 or 200. In an embodiment, the cordless gas/water syringe 600 can be the cordless gas/water syringe 300, 400, or 500. In an embodiment, the cordless gas/water syringe 600 can be any gas/water syringe encompassed by this disclosure. The detachable connection can be via a coupling device 1000 and a connector 2000, which allows the cordless gas/water syringe 600 to draw water from an existing gas/water tubing 10. In an embodiment, the coupling device 1000 and the connector 2000 are integral one-piece. In an embodiment, the coupling device 1000 and the connector 2000 are separate pieces.

In an embodiment, the coupling device 1000 includes a coupler 1001, a body 1005, and thread connector 1013, viewed from top to bottom of FIG. 6A. In an embodiment, the coupling device 1000 further includes, a gas switch 1007, a water switch 1009, and/or a gas/water pressure regulator 1011. The coupler 1001 can removably connect with the cordless air/water syringe 600 for water and/or gas refilling. In an embodiment, the cordless gas/water syringe 600 can be snapped and locked onto the coupler 1001 for a fluidic connection. In an embodiment, the fluidic connection can be locked by rotating the cordless gas/water syringe 600 clockwise about 90°. In an embodiment, the cordless gas/water syringe 600 can be disconnected with the coupler 1001 by about 90° counterclockwise rotation so that the cordless gas/water syringe 600 can be freely used without being physically tied to a water delivery unit in a dental facility. In another embodiment, the cordless gas/water syringe 600 can fluidly connect with the coupler 1001 by press-fit, which locks the cordless gas/water 600 onto the coupler 1001 for water and/or gas refilling. In still another embodiment, the cordless gas/water syringe 600 can fluidly connect with the coupler 1001 by a Camlock fitting or the like for locking the cordless gas/water 600 onto the coupler 1001. In still another embodiment, the cordless gas/water syringe 600 can fluidly connect with the coupler 1001 by a Luer fitting or the like. In an embodiment, the coupler 1001 is replaceable. In an embodiment, the coupler 1001 can be removed by a counter-clockwise rotation.

The gas/water pressure regulator 1011 can regulate the pressure and/or flow rate of gas and water from the air/water tubing 10 to the cordless air/water syringe 600. The gas switch 1007 and the water switch 1009 can turn on and/or shut off the gas and water flow through the coupling device 1001, respectively. During the operation of the coupling device 1000, when the gas switch 1007 and/or water switch 1009 is on, water and/or gas flow through the coupling device 1001; when the gas switch 1007 and/or water switch 1009 is off, water and/or gas cannot flow through the coupling device 1001.

In an embodiment, the body 1005 includes a top end 1003 and a bottom end 1006. The top end can be a flared end for holding the coupling device 1000 onto a dental bracket 3000. In an embodiment, the top end 1003 can have the largest diameter in a range from at or about 25 mm to at or about 30 mm. In an embodiment, the largest diameter of the top end 1003 is at or about 27 mm. In an embodiment, the body 1005 has a tapering diameter from the top end 1003 to the bottom end 1006, in which the bottom end 1006 has the smallest diameter. In an embodiment, the smallest diameter is in a range from at or about 15 mm to at or about 25 mm. In an embodiment, the smallest diameter is at or about 20 mm.

In an embodiment, the coupling device 1000 connects with the connector 2000 via its thread connector 1013. The threaded connector 1013 can be configured to connect with a fastener 2001 of the connector 2000 that is in fluid connection with the gas/water tubing 10. In an embodiment, the fastener 2001 is provided with an internal thread so that the threaded connector 1013 can be screwed onto the fastener 2001 to provide a leak-proof connection therebetween. In an embodiment, the fastener 2001 has a bent body. In an embodiment, the bent body has a bending degree of at or 5 degrees to 90 degrees to prevent the gas/water tip of the cordless gas/water syringe 600 from pointing to a patient when resting on the dental bracket 3000. In an embodiment, the bending degree is at or about 45 degrees or 90 degrees.

In an embodiment, the coupling device 1000 permits the cordless air/water syringe 600 to connect or disconnect with a dental air/water delivery unit system conveniently. When an operator wants to refill the cordless air/water syringe 600, the operator can connect and lock cordless air/water syringe 600 to the coupling device 1000 by rotating it at or about 90 degrees in a clockwise fashion. Once connected, the operator can refill the cordless air/water syringe 600 with water and gas. For example, the water can be refilled by depressing the water-refilling switch 154, and the refiling can be stopped or paused when the water-refilling switch 154 is not depressed or released. When the refilling is completed, the operator can disconnect the cordless air/water syringe 600 with the coupling device 1000 by rotating it at or about 90 degrees in the counterclockwise direction. In an embodiment, the cordless air/water syringe 600 can be operational while being connected with the coupling device 1000 or during refilling. In an embodiment, the cordless air/water syringe 600 can rest on the coupler 1001 when not in operation.

Referring to FIG. 6 B, FIG. 6 B schematically illustrates an exploded view of a connection of the cordless gas/water syringe 600 with the air/water tubing 10 in a dental facility, according to another embodiment. A spacer 1020 can be provided between the bottom end 1006 of the coupling device 1000 and the fastener 2001 of the connector 2000. The spacer 1020 can facilitate mounting of the coupler device 1000 to various dental bracket 3000 in a dental facility. The spacer 1020 can be made from a material including but not limited to rubber, plastic, metal, porcelain, fiber, or combinations thereof. In an embodiment, the spacer 1020 is composed of a rubber material. The spacer 1020 can be various sizes and dimensions suitable for mounting the coupler device 1000 to various dental bracket 3000.

In an embodiment, the connector 2000 and the gas/water tubing 10 are not integral one piece but separable pieces. In an embodiment, the connector 2000 further includes a thread 2043 and fittings 2045, and the gas/water tubing 10 includes an internally threaded receiving assembly 13 and fitting 11. The fitting 11 and the fitting 2045 adopts a mating configuration to each other. The fitting 2045 includes a water inlet 2045a and gas inlet 2045b, which respectively mates with a water outlet 11a and a gas outlet 11b of the gas/water tubing 10 for channeling fluid flows. In an embodiment, the fitting 2045 is a female fitting configured to receiving the fitting 11. After the fitting 11 is attached to the fitting 2045, the internally threaded receiving assembly 13 can be screwed to the thread 2043 and then lock the fitting 11 to the fitting 2045, forming a leak-proof connection between the gas/water tubing 10 and the connector 2000. In an embodiment, the internally threaded receiving assembly 13 is made of metal. In an embodiment, the gas/water tubing 10 is an existing gas/water tubing in a dental facility, and the thread 2043 and the fitting 2045 of the connector 2000 can be configured to fit the existing gas/water tubing.

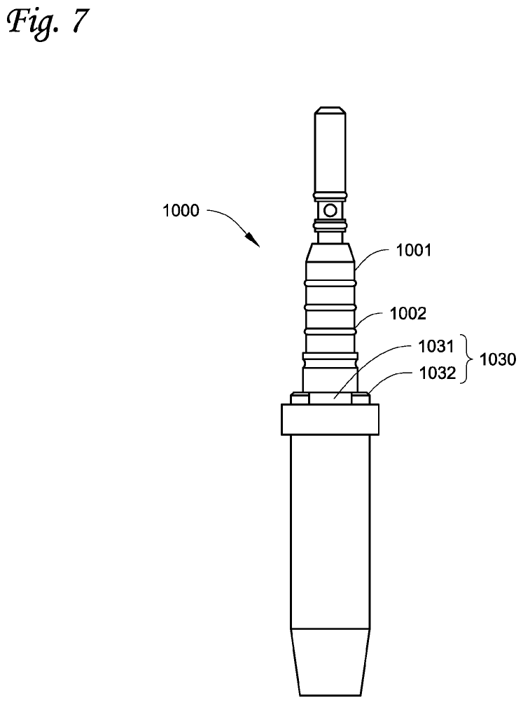

Referring to FIG. 7, FIG. 7 illustrates a coupling device 1000, according to an embodiment. The coupling device 1000 can include a coupler 1001, a plurality of O rings 1002, and a rotation locking mechanism 1030. The plurality of O rings 1002 can provide an air/water tight sealing after the coupler 1001 is attached to a gas/water cordless syringe. The rotation locking mechanism 1030 includes a relief portion 1031 or an aperture and a tapered lip 1032 or a flange. The tapered lip 1032 is interrupted by the relief portion 1031. The cordless gas/water syringe can include a corresponding retention member. When the retention member is aligned with the relief portion and then rotates clockwise about 90°, the cordless gas/water syringe is locked with the coupling device 1000. The cordless gas/water syringe can be disconnected with the coupler 1001 by about 90° counterclockwise rotation so that the coupler 1001 is realigned with the relief portion 2031.

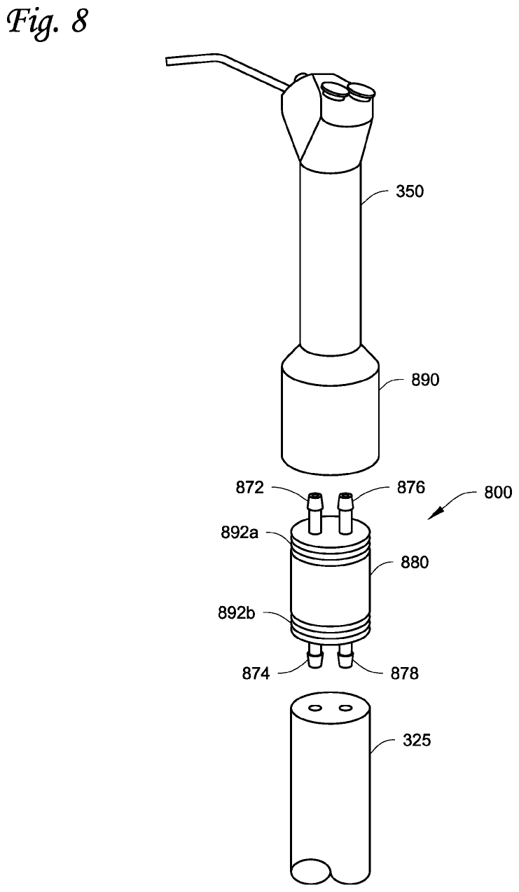

Referring to FIG. 8, FIG. 8 illustrates an adapter 800, according to an embodiment. the adapter 800 can be used to connect gas/water conduits. In an embodiment, the adapter 800 can be the adapter 190 in FIG. 3. The adapter 800 can also be used to connect a gas/water conduit with a gas/water cordless syringe head 350. In an embodiment, the adaptor 800 mediates the fluid connection between the syringe head 350 and the conduit 325. In an embodiment, the adaptor 800 can be used to mediate both fluid connection and electric connections, for example, between the syringe head 350 and the conduit 325. The adapter 800 can include a plurality of connectors for mediating the fluid and or electric connections. In an embodiment, the adapter 800 includes connectors 872, 874, 876, and 878. The connecter 872 can be in fluid connection with the connecter 874, forming a first fluid channel within the adapter 800. The connecter 876 can be in fluid connection with the connecter 878, forming a second fluid channel within the adapter 800. Either of the first and second fluid channels can be a water or gas channel. In an embodiment, the first fluid channel is a water channel, in which the connecter 872 connects to the water conduit of the syringe head 350, and the connector 874 connects to the water conduit in the conduits 325. In an embodiment, the second fluid channel is a gas channel, in which the connecter 876 connects to the gas conduit of the syringe head 350, and the connecter 878 connects to the gas conduit in the conduits 325.

Each of the connectors 872, 874, 876, and 878 can be connected to a corresponding port or tubing of the syringe head 350 or the conduit 325 via various means including, but not limited to, for example, mounting, bracket, plate, clamp assembly, or the like. In an embodiment, the adapter 370 is a push-fit adapter for a quick connection. In an embodiment, the connectors 872, 874, 876, and 878 are push-fit connectors.

The adapter 800 can adopt various shapes suitable for mediating the connection between gas/water conduits or between a gas/water conduit and a unit of a cordless dental syringe disclosed herein. In an embodiment, the adapter 800 has a cylindrical body 880, including a first end and a second end opposing the first end. In an embodiment, the connectors 872 and 876 are disposed on the first end, and the connectors 874 and 878 are disposed on the second end. In an embodiment, the width of the cylindrical body 880 has a diameter in a range of at or about 13 mm to at or about 18 mm. In an embodiment, the length of the cylindrical body 880 is less than at or about 100 mm.

In an embodiment, the cylindrical body includes threads 892a and/or 892b for fixation or mounting between gas/water conduits or between a gas/water conduit and the cordless gas/water syringe head 350. In an embodiment, the connectors 872, 874, 876, and 878 are also provided thread for connection, mounting, and sealing.

In an embodiment, the adapter 800 is in an indirect connection with the syringe head 350. In an embodiment, an intermediate adapter 890 is provided for mediating the connection between the adapter 800 and the syringe head 350. In an embodiment, the adapter 890 permits a preexisting or traditional dental syringe in a dental facility to be used directly without additional modification.

Aspects
Aspect 1. A cordless dental gas/water syringe, comprising a body including:

a water chamber;

a gas chamber;

a water pump;

a gas valve; and

a battery for providing power,

wherein the water chamber is capable of storing water or a container for storing water, and the gas chamber is capable of storing a gas canister containing pressurized gas.
Aspect 2. The cordless dental gas/water syringe as in aspect 1, wherein the body further comprises an adapter, and the adapter fluidly connects with the water pump and the gas valve.
Aspect 3. The cordless dental gas/water syringe as in any one of aspects 1 and 2, wherein the body is configured to a handle and a head extending from the handle.
Aspect 4. The cordless dental gas/water syringe as in any one of aspects 2 and 3, the adapter is provided at a distal end of the head.
Aspect 5. The cordless dental gas/water syringe as in any one of aspects 3 and 4, the handle includes a grooved surface.
Aspect 6. The cordless dental gas/water syringe as in any one of aspects 1 and 2, further comprising a syringe head and a conduit, wherein the conduit fluidly connects the syringe head with the body.
Aspect 7. The cordless dental gas/water syringe as in aspect 6, wherein the conduit removably connects the syringe head.
Aspect 8. The cordless dental gas/water syringe as in any one of aspects 1-7, wherein the body is a wearable body or portable body.
Aspect 9. The cordless dental gas/water syringe as in any one of aspects 1-8, wherein the body is capable of being attached to a belt.
Aspect 10. The cordless dental gas/water syringe as in aspect 9, wherein the belt is a waist belt or arm belt.
Aspect 11. The cordless dental gas/water syringe as in any one of aspects 6-10, wherein the conduit includes at least one water conduit and at least one gas conduit.
Aspect 12. The cordless dental gas/water syringe as in aspect 11, wherein the conduit further includes at least one electric wire.
Aspect 13. The cordless dental gas/water syringe as in any one of aspects 1-12, further comprising a light for illuminating a working area.
Aspect 14. The cordless dental gas/water syringe as in any one of aspects 1-13, further comprising a gas switch, a water switch, and a water-refilling switch,

wherein the gas switch is capable of turning on or off a gas flow from the gas chamber to a working area,

the water switch is capable of turning on or off of a flow of an aqueous solution or water from the water chamber to the working area, and

the water-refilling switch is capable of refilling the water chamber with the aqueous solution or water.
Aspect 15. The cordless dental gas/water syringe as in any one of aspects 1-14, wherein each of the gas switch, the water switch, and the water-refilling switch includes a button.
Aspect 16. The cordless dental gas/water syringe as in aspect 15, wherein the button is thumb-operated.
Aspect 17. The cordless dental gas/water syringe as in any one of aspects 1-16, wherein the water chamber has a mechanism via which a tablet may be insertable into the water chamber.
Aspect 18. The cordless dental gas/water syringe as in aspect 17, wherein the tablet is capable of neutralizing an unpleasant taste or destroying and/or suppressing a cariogenic bacterium.
Aspect 19. The cordless dental gas/water syringe as in any one of aspects 1-19, wherein the water chamber further comprises a port for water refilling.
Aspect 20. The cordless dental gas/water syringe as in any one of aspects 1-20, wherein the body further comprises a water flow regulator and a gas flow regulator.
Aspect 21. The cordless dental gas/water syringe as in any one of aspects 1-20, further comprising a display and an input.
Aspect 22. The cordless dental gas/water syringe as in any one of aspects 1-20, further comprising a display and an input integrated with the display.
Aspect 23. The cordless dental gas/water syringe as in any one of aspects 21 and 22, wherein the input and the display for displaying a graphical user interface (GUI) to an operator provide a plurality of operating selections.
Aspect 24. The cordless dental gas/water syringe as in any one of aspects 21-23, wherein the input and the display are combined as a touchscreen display.
Aspect 25. The cordless dental gas/water syringe as in any one of aspects 1-24, further comprising an output configured to generate a vibration.
Aspect 26. The cordless dental gas/water syringe as in aspect 25, wherein the output is a vibrator or a speaker.
Aspect 25. The cordless dental gas/water syringe as in any one of aspects 1-26, wherein the water chamber includes a container that is removably connected to the body.

With regard to the preceding description, it is to be understood that changes may be made in detail, especially in matters of the construction materials employed and the shape, size, and arrangement of parts without departing from the scope of the present disclosure. This Specification and the embodiments described are exemplary only, with the true scope and spirit of the disclosure being indicated by the claims that follow.

What is claimed is:

1. A cordless dental gas/water syringe, comprising a body including:
a water chamber;
a gas chamber;
a water pump;
a gas valve; and
a battery,
wherein the water chamber is capable of storing water or a container for storing water, the gas chamber is capable of storing a gas canister containing pressurized gas, the body is a wearable body or portable body.

2. The cordless dental gas/water syringe of claim 1, wherein the body further comprises an adapter for connecting a gas/water tip.

3. The cordless dental gas/water syringe of claim 2, wherein the body is configured to a handle and a head extending from the handle, and the adapter is provided at a distal end of the head.

4. The cordless dental gas/water syringe of claim 3, the handle includes a grooved surface that facilitates an operator to grip the cordless dental gas/water syringe.

5. The cordless dental gas/water syringe of claim 1, further comprising a syringe head and a conduit, wherein the conduit fluidly connects the syringe head with the body.

6. The cordless dental gas/water syringe of claim 5, wherein the conduit removably connects to the syringe head and the body.

7. The cordless dental gas/water syringe of claim 5, wherein the conduit includes at least one water conduit and at least one gas conduit.

8. The cordless dental gas/water syringe of claim 7, wherein the conduit further includes at least one electric wire.

9. The cordless dental gas/water syringe of claim 1, wherein the body is capable of being attached to a belt.

10. The cordless dental gas/water syringe of claim 9, wherein the belt is a waist belt or arm belt.

11. The cordless dental gas/water syringe of claim 1, further comprising a light for illuminating a working area.

12. The cordless dental gas/water syringe of claim 1, further comprising a gas switch, a water switch, and a water-refilling switch,
wherein the gas switch is capable of turning on or off a gas flow from the gas chamber to a working area,
the water switch is capable of turning on or off of a flow of an aqueous solution or water from the water chamber to the working area, and
the water-refilling switch is capable of refilling the water chamber with an aqueous solution or water.

13. The cordless dental gas/water syringe of claim 12, wherein each of the gas switch, the water switch, and the water-refilling switch includes a button.

14. The cordless dental gas/water syringe of claim 13, wherein the button is a thumb operatable button.

15. The cordless dental gas/water syringe of claim 1, wherein the water chamber has a mechanism via which a chemical tablet or solution is added into an aqueous solution or water in the water chamber.

16. The cordless dental gas/water syringe as of claim 15, wherein the chemical tablet or solution is capable of neutralizing an unpleasant taste or destroying and/or suppressing a cariogenic bacterium.

17. The cordless dental gas/water syringe of claim 1, wherein the water chamber further comprises a port for water refilling.

18. The cordless dental gas/water syringe of claim 1, wherein the body further comprises a display and an optional button.

19. The cordless dental gas/water syringe of claim 18, wherein the display is capable of displaying a graphical user interface (GUI) to an operator providing a plurality of operating selections.
